(19) United States
(12) Patent Application Publication
(10) Pub. No.: US 2020/0224970 A1
(43) Pub. Date: Jul. 16, 2020

(54) Organic and Mineral Personal Home Dryer

(71) Applicant: Scott Lee Salisbury, Rancho Santa Margarita, CA (US)

(72) Inventor: Scott Lee Salisbury, Rancho Santa Margarita, CA (US)

(21) Appl. No.: 16/168,844

(22) Filed: Jan. 10, 2019

(51) Int. Cl. F26B 9/00; A23L 3/40

(52) U.S. Cl. CPC F26B 9/003; A23L 3/40

(57) ABSTRACT

A personal air drying appliance uses controlled time and air volume to dry organics and minerals to specific tolerances so as not to destroy or change the organic materials or minerals so they do not lose their intrinsic value or highest and best use by maintaining the integrity of the material in the controlled drying state. A convenient, small, personalized, counter top appliance with operating timer and air quantifier.

### BRIEF SUMMARY OF THE INVENTION

A small, personal appliance simply used to give constant air drying to material or product, i.e organics such as herbs, spices, seedlings and/or valuable minerals or stones.

This personal, home drying appliance has a middle shelf with egg crate type receptacle indentations, with aeration holes to allow for constant and consistent air drying of, but not limited to, the above mentioned products.

The size of the round appliance is just slightly smaller than a bowling ball. The interior holds a timer and fan mechanism to control the timing of the drying appliance.

This personal, drying appliance is simple to use—put organic product or mineral of small size into the receptacle indentations and set timer for the fan usage. Air dry for precisely the time set and remove product when satisfied with result.

### BRIEF DESCRIPTION OF THE SEVERAL VIEWS OF THE DRAWING

Page 1/8

FIG. 1 Split view of the three main attached parts of the invention—top part, middle part with drying pits and bottom part for fan, power source and timer piece.

Page 2/8

FIG. 2 Side view of the timer.

FIG. 3 Side view of power source portal.

Page 3/8

FIG. 4 Timer mechanism.

FIG. 5 Side view of bottom third part with attachment features.

Page 4/8

FIG. 6 Top view of bottom part.

FIG. 7 Side angle/bottom view of the third and bottom part.

Page 5/8

FIG. 8 Top, side angle view of bottom, third part.

FIG. 9 Top view of middle, drying part.

Page6/8

FIG. 10 Side view of middle, drying part.

FIG. 11 Top, side angle view of middle, drying part.

7/8

FIG. 12 Bottom, side angle view of middle, drying part.

FIG. 13 Top view of assembly attachment piece to attach middle and bottom parts.

FIG. 14 Side view of assembly attachment piece to attach middle and bottom parts.

8/8

FIG. 15 Side view of top part.

FIG. 16 Top view of top part.

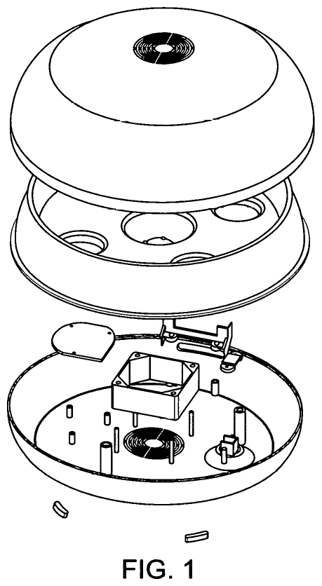

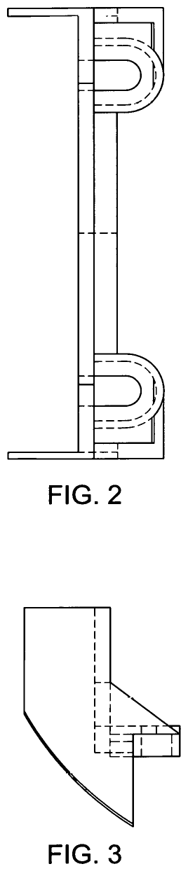

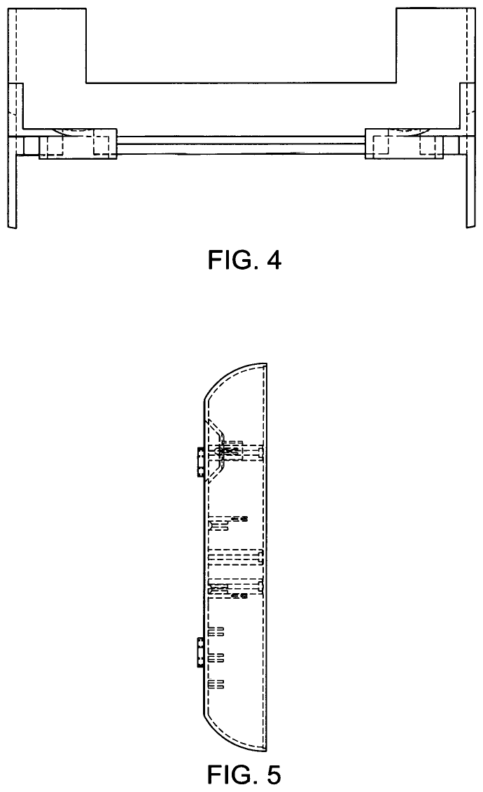

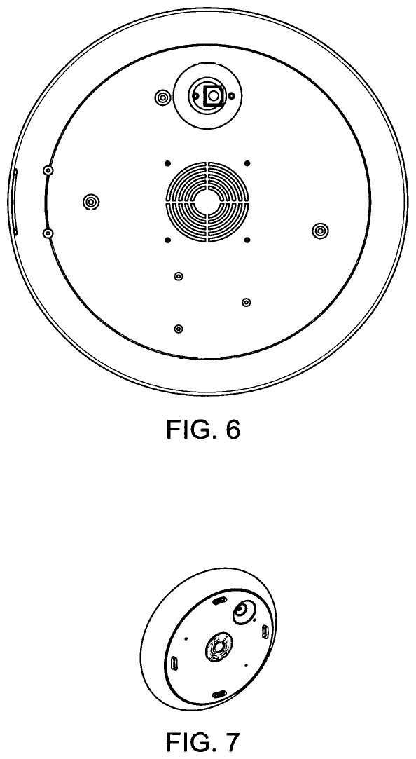

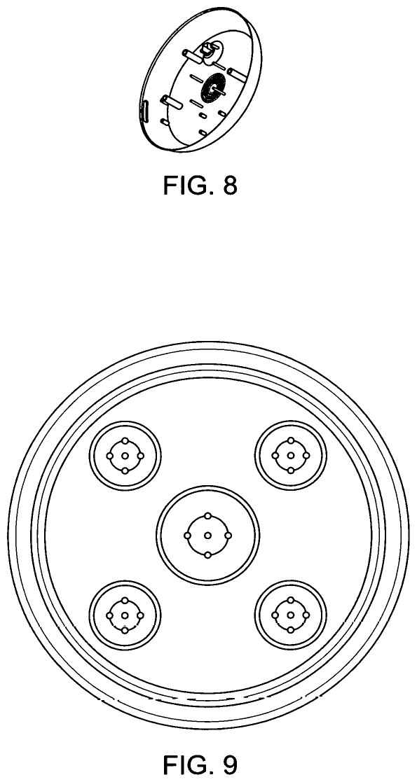

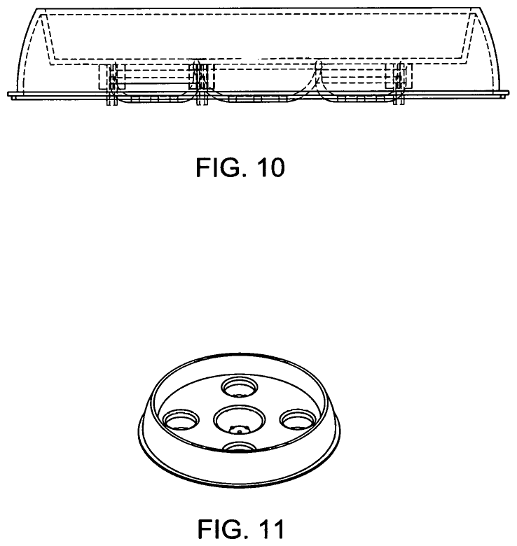

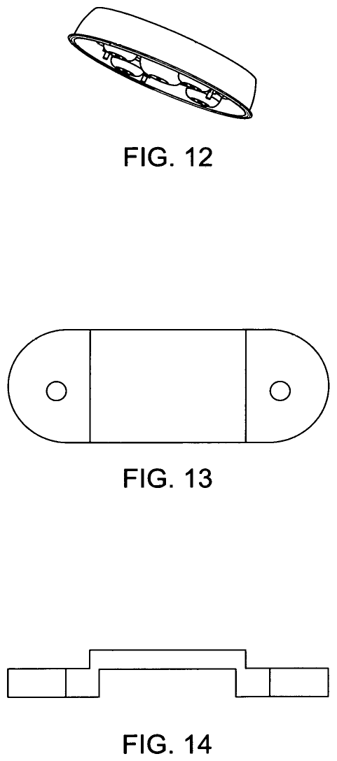

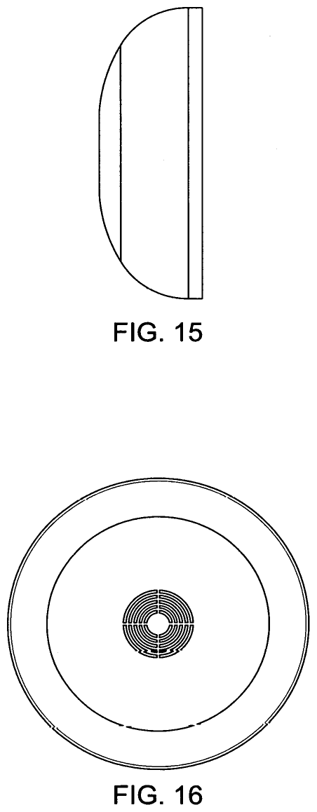

### DETAILED DESCRIPTION OF THE INVENTION

A small, personal appliance simply used to give constant air drying to material or product, i.e organics such as herbs, spices, seedlings and/or valuable minerals or stones.

Manufacturing would include plastic injected 3-D molds with three electrical part assemblies with an exterior of distinctive and popular art designs. Manufactured by injecting liquid plastic into the moldings made from 3-D molds, the assembly line production process would add the small electronics (electric component timer, small fan and power portal) and finish work.

There is no product in the market to compare this invention to as there is nothing similar.

1. The Organic and Mineral Personal Home Dryer is a small, personal appliance simply used to give constant, consistent and controlled air drying to material or product, i.e organics such as herbs, spices, seedlings and valuable minerals or stones. This appliance will allow the individual to set their prescribed time to dry organics and/or eliminate moisture in cracks in minerals and stones—excellent for craftsmen and collectors.
